(19) United States
(12) Patent Application Publication
(10) Pub. No.: US 2009/0037349 A1
(43) Pub. Date: Feb. 5, 2009

(54) SYSTEM AND METHOD FOR MANANGING TRAVEL CLUBS

(75) Inventors: Jennifer Katz, Minneapolis, MN (US); Brian R. Stuckey, Minneapolis, MN (US)

Correspondence Address: SCHWEGMAN, LUNDBERG & WOESSNER, P.A., P.O. BOX 2938, MINNEAPOLIS, MN, 55402, US

(73) Assignee: Accredited Only, Inc., Minneapolis, MN (US)

(21) Appl. No.: 12/183,874

(22) Filed: Jul. 31, 2008

Related U.S. Application Data
(60) Provisional application No. 60/952,921, filed on Jul. 31, 2007.

(51) Int. Cl. G06Q 10/00

(52) U.S. Cl. 705/400

(57) ABSTRACT

Systems and methods for managing travel clubs are described. A system comprises a client computer; a server computer, communicatively connected to the client computer with a network system; and a processing system to run on the client computer, wherein the processing system is configured to: present indications of a plurality of participating airlines to a user, wherein the participating airlines are included in a travel club; receive a selection of at least one airline from the plurality of airlines from the user; and use a pricing model to determine a fare for a flight associated with the selected at least one airline, wherein the pricing model is associated with the travel club.

### RELATED PATENT DOCUMENTS

This patent application claims the benefit of priority, under 35 U.S.C. Section 119(e), to U.S. Provisional Patent Application Ser. No. 60/952,921, “Systems and Methods for Managing Travel Clubs,” filed on Jul. 31, 2007, the contents of which are incorporated herein in their entirety.

### TECHNICAL FIELD

Various embodiments described herein relate generally to computer systems, and more particularly, but not by way of limitation, to systems and methods for managing travel clubs.

### BACKGROUND

Computerized reservation systems are used to store information related to travel and conduct transactions, such as searching or sorting available airline reservations or tickets. These systems may also be used to purchase, sell, or track tickets or other inventory. In addition, reservation systems may be used to book hotels, rental cars, or other services associated with a ticket or ticket reservation.

### BRIEF DESCRIPTION OF THE DRAWINGS

FIG. 1 is a schematic view of a computer network system according to various embodiments.

FIG. 2 is a schematic diagram illustrating a travel club system according to various embodiments.

FIGS. 3-8 are block diagrams illustrating travel club configurations according to various embodiments.

FIG. 9 is a flowchart illustrating a method of signing up for a travel club according to various embodiments.

FIG. 10 is a flowchart illustrating a method of accessing a travel club according to various embodiments.

FIG. 11 is a flowchart illustrating a method of configuring a travel club according to various embodiments.

FIG. 12 is an example of a graphical user-interface according to various embodiments.

FIG. 13 is a block diagram illustrating a machine in the example form of a computer system, within which a set or sequence of instructions for causing the machine to perform any one of the methodologies discussed herein may be executed, according to various embodiments.

### DETAILED DESCRIPTION

The following detailed description includes references to the accompanying drawings, which form a part of the detailed description. The drawings show, by way of illustration, example embodiments. These embodiments, which are also referred to herein as “examples,” are described in enough detail to enable those skilled in the art to practice aspects of the inventive subject matter.

In this document, the terms “a” or “an” are used, as is common in patent documents, to include one or more than one. In this document, the term “or” is used to refer to a nonexclusive or, unless otherwise indicated.

### System Overview

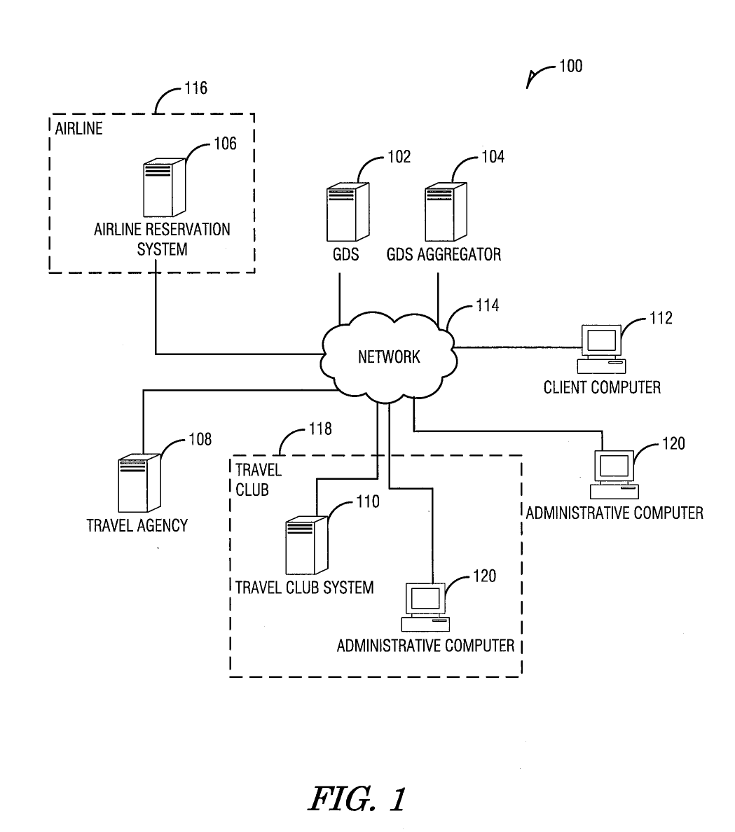

FIG. 1 is a schematic view of a computer network system 100 according to various embodiments. The computer network system 100 includes a global distribution system (GDS) 102, a global distribution system (GDS) aggregator 104, an airline reservation system 106, a travel agency 108, a travel club system 110, a client computer 112, and an administrative computer 120, all communicatively coupled via a network 114.

The GDS 102 may include a computer reservation system for one or more airlines. Examples of a GDS 102 include Amadeus Global Travel Distribution System provided by Amadeus IT Group SA of Madrid, Spain; Sabre GDS provided by Sabre Holdings' Sabre Travel Network of Southlake, Tex.; Galileo Central Reservations System provided by Travelport of Parsippany, N.J.; and Worldspan provided by Worldspan L.P. of Atlanta, Ga.

The GDS aggregator 104 may allow a user to access several GDS systems in an integrated system. Examples of a GDS aggregator 104 include Triton Distribution Systems of Sausalito, Calif.; ITA Software of Cambridge, Mass.; G2 Switchworks of Chicago, Ill.; and Farelogix of Miami, Fla.

The airline reservation system 106 may be provided by, or associated with, an airline 116 and may be configured to manage ticket sales, reservations, and other aspects of airline services. Airlines 116 may provide direct access to a pool of tickets set aside to bypass the fees and costs associated with using a GDS 102 service or a GDS aggregator 104 service. Examples of an airline reservation system 106 may include websites, such as www.nwa.com provided by Northwest Airlines, Inc. of Minneapolis, Minn.; and www.aa.com provided by AMR Corp. of Fort Worth, Tex.

The travel agency 108 may include online travel agencies, such as expedia.com provided by InterActiveCorp of New York, N.Y.; and travelocity.com provided by Sabre Holdings of Southlake, Tex. The travel agency 108 may also include conventional brick-and-mortar businesses that access a GDS 102, GDS aggregator 104, airline reservation system 106, or other travel agency 108 via the network 114 on behalf of a customer or client looking to reserve a flight or make other travel arrangements.

The travel club system 110 may include an online system to provide private or preferential travel services to clients. For example, a travel club 118 may provide preferential air fare, rental car rates, hotel room rates, or other travel packages to members of the travel club. In some embodiments, the travel club system 110 may be associated with an airline 116 or airline reservation system 106, a travel agency 108, or a GDS 102. In an embodiment, the travel club system 110 may aggregate private membership clubs provided by two or more airlines 116, travel agencies 108, or other travel organizations.

To access the systems described above, a user (not shown) may use a client computer 112 to connect and interface with one or more systems via the network 114. The client computer 112 may include a laptop computer, portable computer, personal digital assistant (PDA), mobile telephone (e.g., cellular telephone), desktop computer, or other specialized computing device (e.g., a kiosk). The client computer 112 may include one or more processors, which when acting in concert with memory, display drivers, storage devices, input devices, and other components of the client computer 112, form a processing system. The processing system may be configured to present a user interface to the user; receive input from the user; search, compute, aggregate, or otherwise process the input; and provide an output to the user. The client computer 112 may interface with the systems described using a standardized protocol or a proprietary protocol to communicate in a secured or unsecured manner over the network 114. For example, the client computer 112 may connect with the travel club system 110 using Secure Hypertext Transfer Protocol (e.g., https) over a Transmission Control Protocol/Internet Protocol (TCP/IP) network. As another example, the client computer 112 may connect with the travel club system 110 using a virtual private network (VPN).

The network 114 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 114 may include a single local area network (LAN) or wide-area network (WAN), or combinations of LAN's or WAN's, such as the Internet. The various devices and systems coupled to the network 114 may be coupled to the network 114 via one or more wired or wireless connections.

The administrative computer 120 may include a personal computer, terminal computer, a laptop computer, portable computer, personal digital assistant (PDA), mobile telephone (e.g., cellular telephone), desktop computer, or other specialized computing device (e.g., a kiosk), in various embodiments. In an embodiment, the administrative computer 120 is located remotely from the travel club 118. For example, an administrative user (not shown) may use a portable computer to access the travel club system 110, such as via a web browser, to control or configure one or more aspects of a travel club 118 (e.g., participating airlines, pricing models, user accounts, etc.). In an embodiment, the administrative computer 120 may be located in the same physical (e.g., local area network) or logical network (e.g., virtual private network) as the travel club system 110.

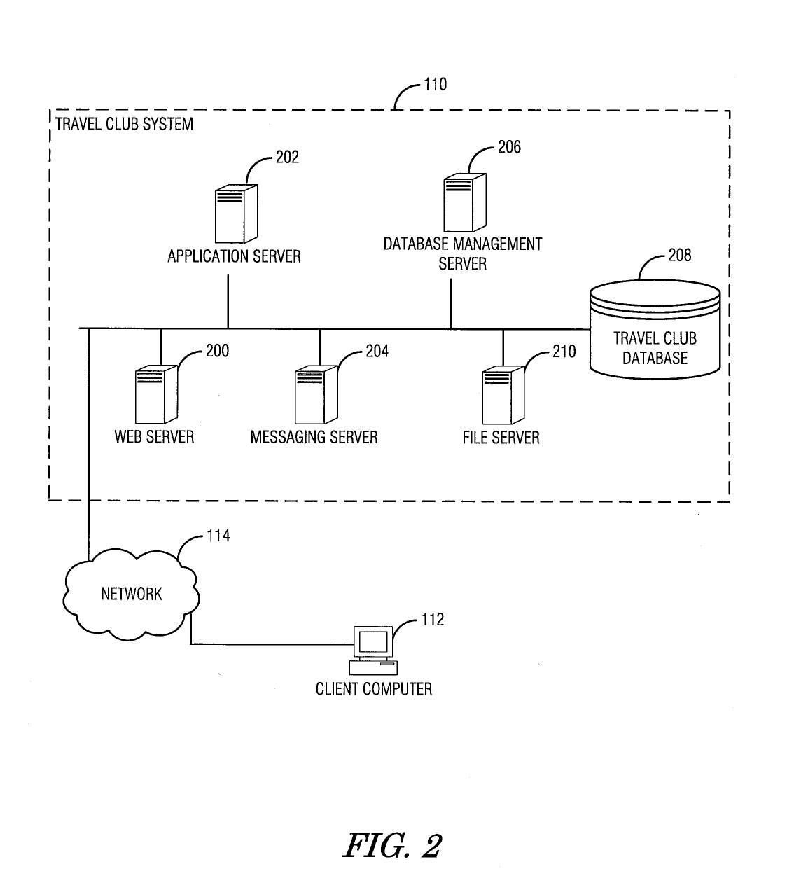

FIG. 2 is a schematic diagram illustrating a travel club system 110 according to various embodiments. In an embodiment, the travel club system 110 includes a web server 200, an application server 202, a messaging server 204, a database management server 206, which is used to manage at least a travel club database 208, and a file server 210. The travel club system 110 may be implemented as a distributed system, for example one or more elements of the travel club system 110 may be located across a wide-area network from other elements of the travel club system 110.

The web server 200 may communicate with the file server 210 to publish or serve files stored on the file server 210. The web server 200 may also communicate or interface with the application server 202 to enable web-based presentation of information. For example, the application server 202 may consist of scripts, applications, or library files that provide primary or auxiliary functionality to the web server 200 (e.g., multimedia, file transfer, or dynamic interface functions). In addition, the application server 202 may also provide some or the entire interface for the web server 200 to communicate with one or more of the other servers in the travel club system 110, e.g., the messaging server 204 or the database management server 206.

The travel club database 208 may include data to administer, track, audit, and provide reports on data associated with a travel club. For example, the travel club database 208 may be structured to include some or all of the following information: a client identifier (e.g., a person's name, a business entity's name, a tax identification number), a travel club type (e.g., a restricted access, a full access, or a bronze, silver, or gold membership), an airline election (e.g., election of airlines selected from participating airlines), itineraries, billing data (e.g., bank account, credit card account), tracking data (e.g., creation date, last modified date, identities of persons who viewed or modified data), and other related data (e.g., membership status, contact information, security information such as username and password). The travel club database 116 may be implemented as a relational database, a centralized database, a distributed database, an object oriented database, or a flat database in various embodiments. It can be appreciated that other database formats and organizations may be used to implement the systems and methods described herein.

In an embodiment, a user (not shown) at a client computer 112 may interface with the travel club system 110, such as by using the web server 200, to sign-in and manage club activities. For example, the user may be presented with options, such as building a flight itinerary, in a simple interface provided by the web server 200. After submitting a flight itinerary, the user may be presented with one or more options of possible flights and corresponding fares. The user may be provided selected fares based on the user's membership status with the travel club 118. Other configurations are described below.

In some embodiments the user is a member of the travel club. In other embodiments, the user is an agent of the potential traveler (e.g., a travel agent, secretary, personal assistant, parent, spouse, or the like).

One or more of the systems or entities described with reference to FIG. I may obtain and manage a pool of tickets. For example, a travel agency 108 may purchase a set of tickets from one or more airlines and offer those tickets to customers of the travel agency 108. As another example, an airline 116 may reserve a set of tickets to sell using their airline reservation system 106, as it may be less costly than using a GDS 102 or GDS aggregator 104. As yet another example, a travel club 118 may have access to a set of tickets, which may be reserved or set aside by agreement with the one or more airlines associated with the travel club 118. Some tickets may be pre-purchased, purchased outright, or otherwise acquired by the travel club 118 to re-sell to its members.

### Travel Club Configurations

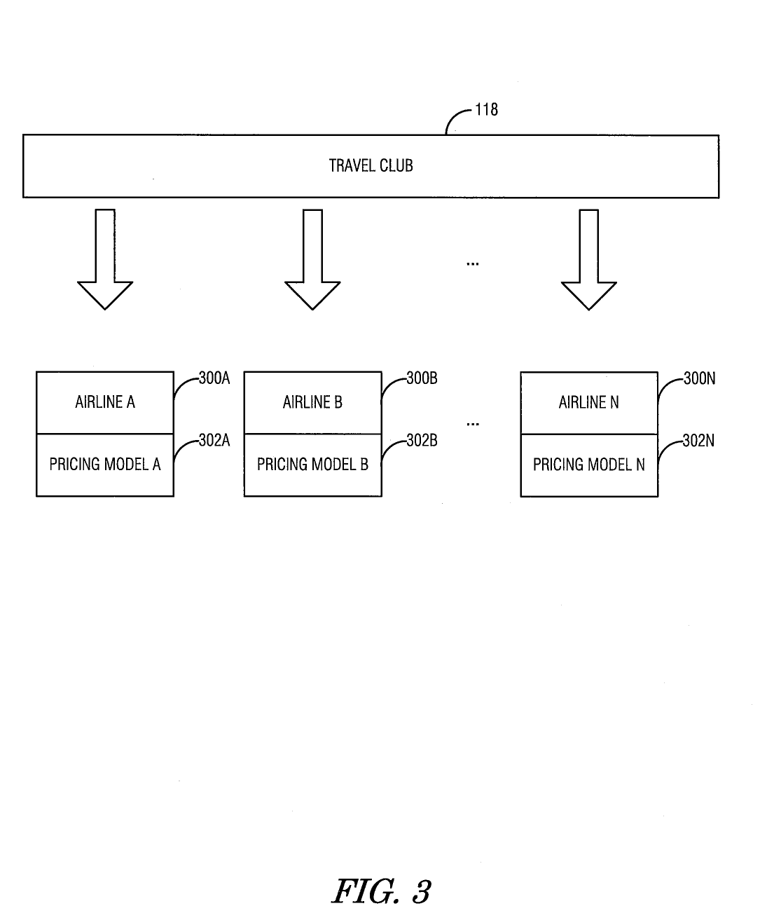

FIG. 3 is a block diagram illustrating a travel club configuration according to various embodiments. In the configuration shown in FIG. 3, a user (e.g., a traveler) may access a travel club 118, where the travel club 118 includes one or more airlines 300A, 300B, . . . , 300N (collectively 300). In such a configuration, the user may pay a fee (e.g., a membership fee), which may include an initial fee, such as a sign-up or initiation fee, and an ongoing subscription or maintenance fee (e.g., a monthly due). In return for the fee, the user is given access to the airlines 300 associated with the overarching travel club 118. The user may be given access to preferred pricing using one or more pricing models 302A, 302B, . . . , 302N (collectively 302), with each pricing model 302 being associated with an airline 300. Pricing models 302 may include, but are not limited to, discounts using a flat rate or percentage of the regular, non-discounted price or fare; flat-rate pricing; tiered pricing (e.g., based on a membership level or status); pricing using the number of miles related to a flight or other travel itinerary; zone pricing (e.g., based on travel distance or geographic boundaries); or band pricing. In addition, combinations or permutations of these pricing models may be used. For example, a tiered pricing structure may be used in combination with a discount pricing structure, such that a member in the highest tier may obtain deeper discounts on already reduced base prices when compared to a member in a lower tier. A brief description of these pricing models is described next; however, it is understood that these pricing models merely provide examples of possible pricing models and that the present description is not limited to the ones described.

Discount pricing includes reducing a generally-available price by an amount. The amount may be a fixed amount, such as $10, or a percentage amount, such as 10%. A generally-available price may be one that is published to a GDS or a GDS aggregator. Generally-available prices may also include those prices that are advertised, such as in news print, within online media, or other broadcast media (e.g., television or radio).

Flat rate pricing includes providing a fixed price to a customer. The fixed price may be in comparison to variable prices offered via various outlets (e.g., different GDS systems or different booking companies). The fixed price may be static with respect to time of booking, for example, a customer may be provided a set price regardless of when the customer books a flight. This is in contrast to many systems and airlines that provide dynamic pricing using factors such as seat availability, booking time before the scheduled flight departure, and the like.

Tiered pricing includes providing two or more tiers for members. Tiers may be separated by providing higher tiers with more benefits, which may entail the use of higher membership fees. Benefits may include reduced pricing; increased promotional credits per flight or per mile (e.g., bonus points, miles, or membership points); preferential treatment with respect to seating, booking, in-flight entertainment or meals, or auxiliary services such as car rentals, hotels, connecting flights, limousines, show or attraction tickets, and the like. Each tier may be designed for members with different needs, for example, by varying the membership fee associated with a tier, members may be able to choose a tier that aligns with their budgets with respect to their travel needs.

Pricing based on miles traveled or other aspects of a travel itinerary include configurations such as a flat rate price per mile, or a reduced price for each additional service used (e.g., booking a car or hotel along with a flight). Flat rate pricing per mile may be combined with a flat rate price configuration, for example, by capping the maximum a member may pay using a flat rate, while charging the member a flat rate price per mile up to the maximum cap. As an example, a combined configuration may be a $0.25 per mile cost with a maximum of $400. Other combinations may include a geographic limitation to a flat rate pricing scheme. For example, the combine flat rate and flat rate per mile configuration may not be available for flights to Alaska and Hawaii from the continental United States.

Zone pricing may resemble the geographically-limited flat rate per mile configuration described above. As an example, states or regions may be clustered or grouped together to for a common price. Zone pricing may also use one or more aspects of an itinerary, such as distance, dates traveled, fare price, or the like.

Band pricing may be based on one or more aspects of an itinerary, such as a booking class, a fare class, a distance, dates traveled, a fare price, or the like. An airline may standardize its booking classes using a class code. For example, “A” may represent “First Class Discounted,” “B” may represent “Economy Full Fare,” and “C” may represent “Full-fare Business Class.” Other classes may be used to fully describe the various fare rates and service levels available on a particular flight or for a particular airline. Band pricing may be combined with other pricing models, such as fixed pricing to provide price confidence to potential travelers, as an example.

A further aspect of band pricing may include pricing bands within each class. For example, within the booking class “B” (“Economy Full Fare”) there may be two or more separate groups, where each group is associated with a price for the booking class. The group pricing may be conceptually arranged from lowest to highest, such that each customer that is seeking to book a flight is provided the price of the lowest available fare grouping. When the customer books the flight, one fo the seats in the booking class' fare group is consumed. Once all of the fares in the group are consumed, then the next higher fare is made available for subsequent customers. In an embodiment, a pricing model is available to a subscribing member that includes band pricing with a guaranteed ability to purchase from a particular fare group, even if the fare group was sold out or not otherwise available to the public. This may include an additional cost to ensure the availability of the fare group.

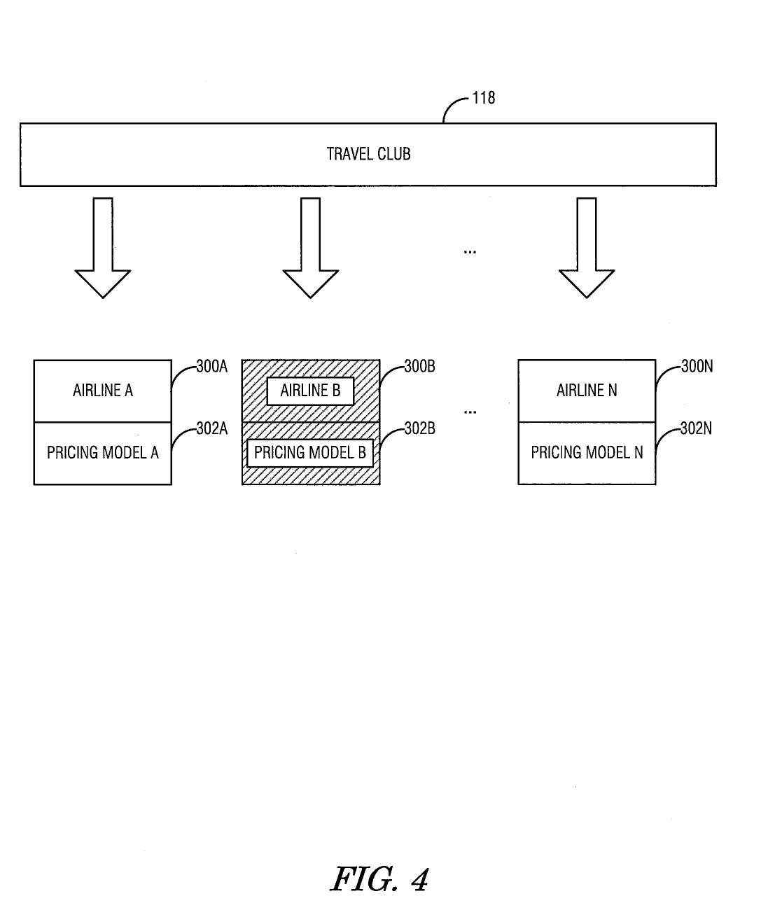

FIG. 4 is a block diagram illustrating a travel club configuration according to various embodiments. In the configuration shown in FIG. 4, a user may access a travel club 118 to access one or more airlines 300, similar to that described in FIG. 3. However, the travel club configuration illustrated in FIG. 4 differs from that illustrated in FIG. 3 in that the travel club 118 in FIG. 4 permits the user to select which airlines are available to the user, from a group of participating airlines. In the embodiment shown, airlines 300A, 300B, . . . , 300N are available to a user through the travel club 118. However, the user has elected to exclude “Airline B” 300B (shown grayed out). There may be reasons why a user would choose to include or exclude airlines 300. For example, the membership fee for the travel club 118 may be based in part, or in whole, on the number of participating airlines elected by the user. As another example, some airlines that have a limited geographic coverage may be less desirable than others for a particular user. Whatever the case may be, the user is given the opportunity to opt-out of participating airlines 300.

In an embodiment, the user is initially given access to all participating airlines 300 and is given the ability to exclude, opt-out, or remove airlines 300 from their membership coverage. In an alternative embodiment, the user is asked, for example during account creation, which airlines 300 from a group of participating airlines, the user would like to include. The user may add or remove airlines 300 from their membership coverage from time to time. For example, the user may be provided control, for example, via a web-based system, such as the travel club system 110, to add or remove airlines 300. As new participating airlines are added to a travel club 118 or as airlines 300 removed from participation, the user may be notified (e.g., via email) and may opt to add or replace the newly added or removed airlines. In some embodiments, airlines may be modified on a restricted schedule (e.g., only once a month or only once every three months) to reduce possible abuse of the travel club 118.

In general, the opportunity to opt-in or opt-out of participating airlines 300 may be provided at various times during the user's membership. The user may be provided a mechanism to modify or revise the selected airlines 300 at any time during their membership. Alternatively, the user may be provided a limited number of opportunities to modify, alter, or revise the selected airlines 300, such as periodically (e.g., monthly or annually), a determined number of time (e.g., four times a year), or on a pay-per-event basis (e.g., a surcharge is issued to implement a revision on the user's account). Other mechanisms, such as user membership levels (e.g., bronze, silver, or gold) may be used to further structure when or whether a user may alter a selection of participating airlines 300. For example, a “gold level” user may be allowed to revise their selection five times a year, whereas a “bronze level” user may only be allowed to revise their selection once a year.

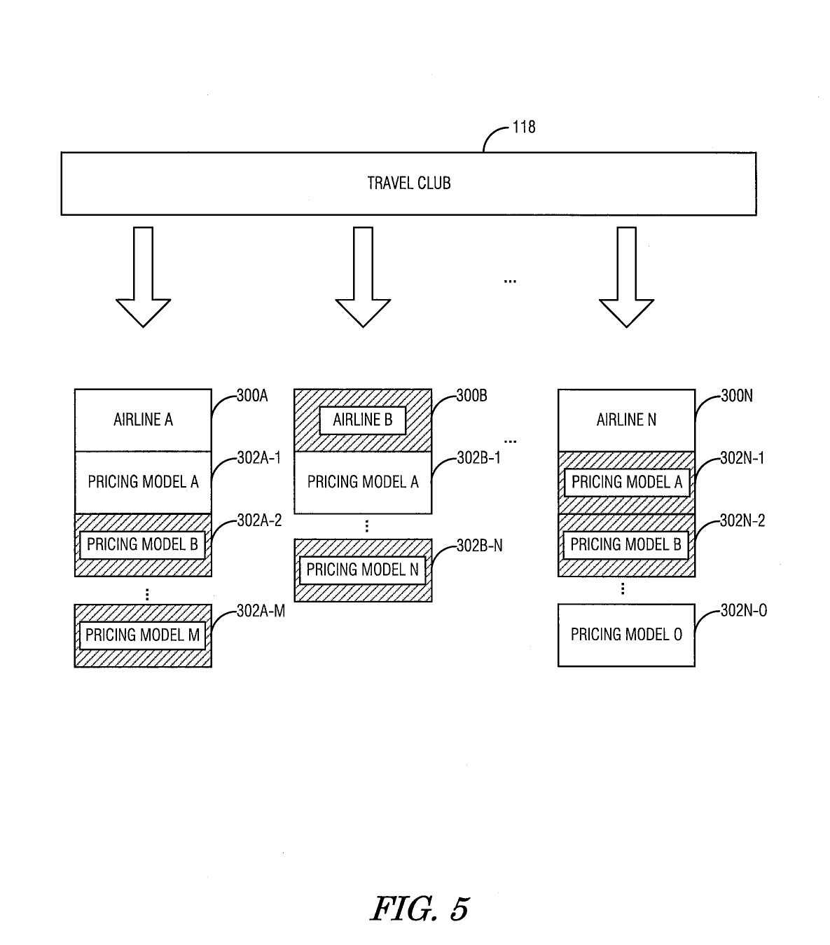

FIG. 5 is a block diagram illustrating a travel club configuration according to various embodiments. In the configuration shown in FIG. 5, a user may access a travel club 118 to access one or more airlines 300, similar to that described in FIGS. 3 and 4. However, the travel club configuration illustrated in FIG. 5 differs from those in FIGS. 3 and 4 in that the travel club 118 in FIG. 5 each airline 300 has one or more pricing models 302 associated with it. For example, “Airline A” 300A offers the travel club member three pricing models to choose from, “Pricing Model A” 302A-1, “Pricing Model B” 302A-2, and “Pricing Model C” 302A-3 (collectively 302). The pricing models may include models, such as those described above. In an embodiment, the user may choose which pricing model 302 to use for a particular airline 300. In another embodiment, the travel club 118 may assign a pricing model 302 for a particular airline 300 to the user based on various criteria, such as the user's membership status, the user's purchase history, the user's demographic data, or other factors. For example, a travel provider may determine that a user's income can be a useful indicator of how much a person may travel, such that a user with a higher income may be provided a different pricing model 302 based on such information. In some embodiments, the user may be able to change pricing models 302 on a restricted basis, such as monthly, quarterly, or annually. The restricted basis may also be controlled in part or in whole by the user's membership status, purchase history, travel history, or other characteristics of the user.

In the example shown in FIG. 5, the user has selected “Airline A” 300A and “Airline N” 30ON to include in their membership coverage and within “Airline A” 300A, the user has selected “Pricing Model A” 302A-1, and within “Airline N” 300N, the user has selected “Pricing Model O” 302N-O. Although the pricing model “Pricing Model A” 302B-1 is selected, because it is associated with a non-elected airline, “Airline B” 300B, the selection is irrelevant. However, should the user elect “Airline B” 300B at some time, the selected pricing model will become active.

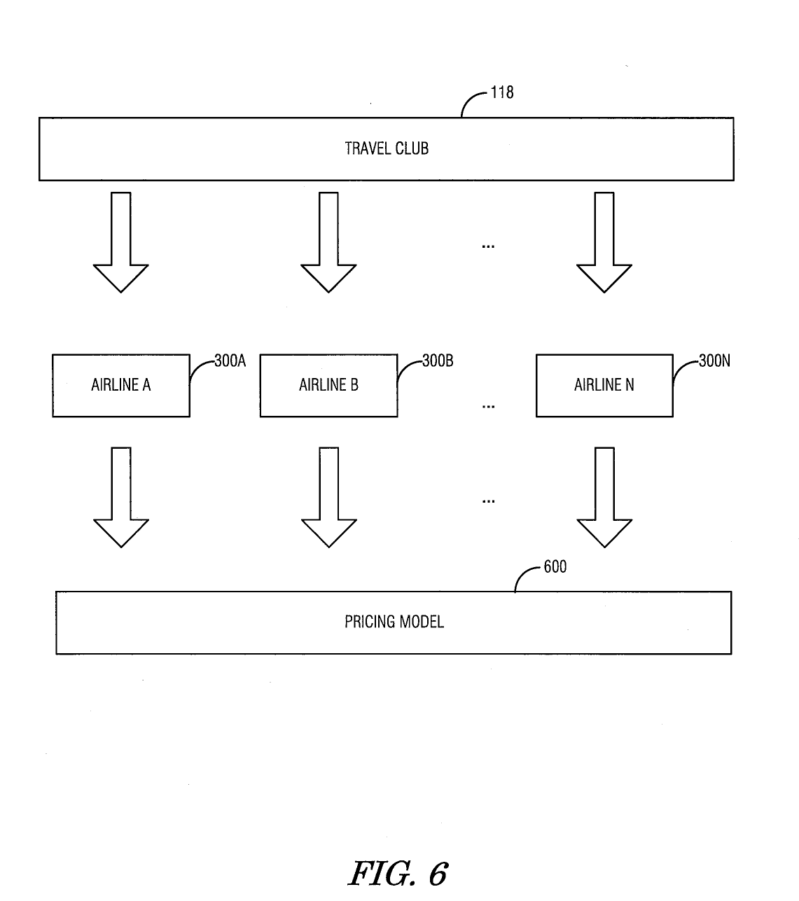

FIG. 6 is a block diagram illustrating a travel club configuration according to various embodiments. In the configuration shown in FIG. 6, a user may access a travel club 118 to access one or more airlines 300, similar to that described in FIGS. 3-5. However, the travel club configuration illustrated in FIG. 6 differs from those in FIGS. 3-5 in that the travel club 118 in FIG. 6 each airline 300 is only associated with a single pricing model 600. In an embodiment, the pricing model 600 may be chosen by the travel club 118. In another embodiment, the pricing model 600 is chosen by agreement between the travel club 118 and the airlines 300.

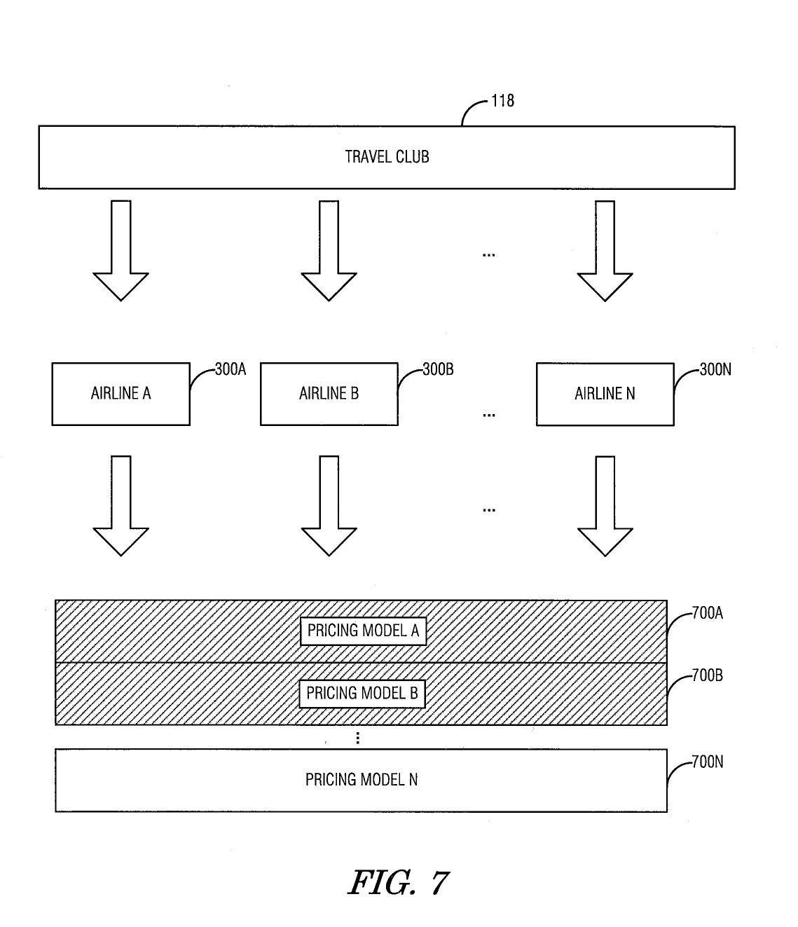

FIG. 7 is a block diagram illustrating a travel club configuration according to various embodiments. In the configuration shown in FIG. 7, a user may access a travel club 118 to access one or more airlines 300, similar to that described in FIGS. 3-6. However, the travel club configuration illustrated in FIG. 7 differs from those in FIGS. 3-6 in that the travel club 118 in FIG. 7 provides a selection of two or more pricing models 700A, 700B, . . . , 700N (collectively 700). The selected pricing model is then used across all participating airlines. Similar to the configuration illustrated in FIG. 7, the available pricing models 700 may be chosen by the travel club or alternatively by agreement between the travel club and the participating airlines.

The embodiments illustrated and described in FIGS. 3-7 may be combined or integrated in various ways to provide a multitude of possible configurations. For example, a user may be provided control to select a single pricing model from a group of pricing models (e.g., FIG. 7) and also select one or more airlines 300 from a group of participating airlines (e.g., FIG. 4). Moreover, while a relatively small number of airlines and pricing models are illustrated, it is within the scope of the invention to include any number of airlines or pricing models in a particular implementation of a travel club.

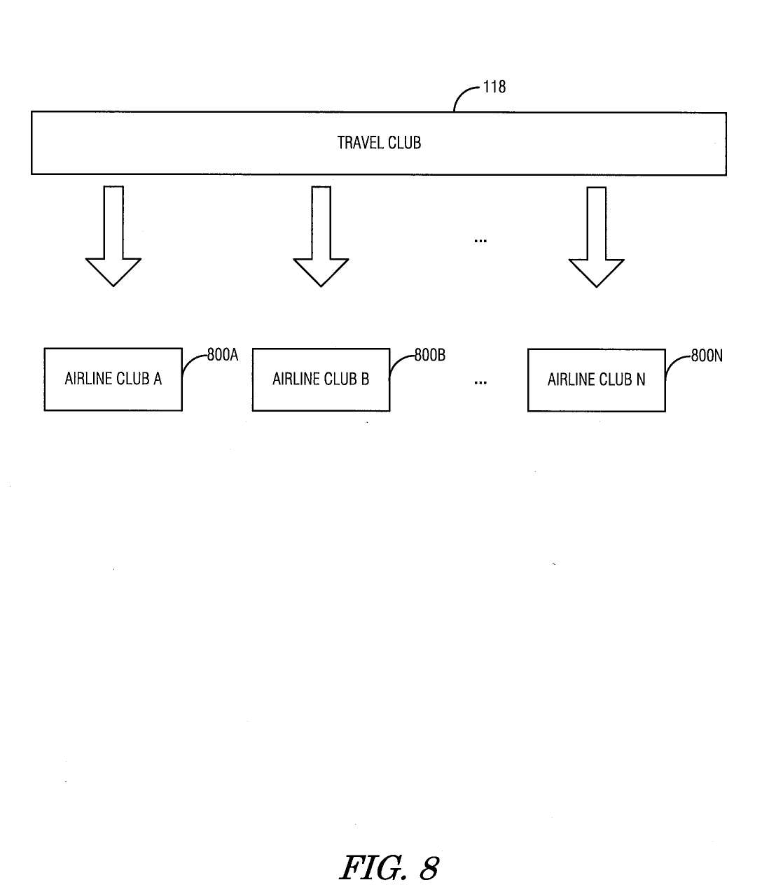

FIG. 8 is a block diagram illustrating a travel club configuration according to various embodiments. In the configuration shown in FIG. 8, a user may access a travel club 118, where the travel club 118 includes one or more airline travel clubs 800A, 800B, . . . , 800N (collectively 800). For example, a user may pay a single membership fee to the travel club 118 for access to each participating airline travel club 800. This configuration may be attractive to a user for ease of administration among several travel clubs. There may also be other benefits provided by the overarching travel club 118, such as shared miles or other premiums to be used from one airline club 800 with another airline club 800, or inter-airline itineraries claiming benefit to each respective club's membership participation features (e.g., reduced airfare, package pricing, preferred seating, etc.).

### Methods of Operation

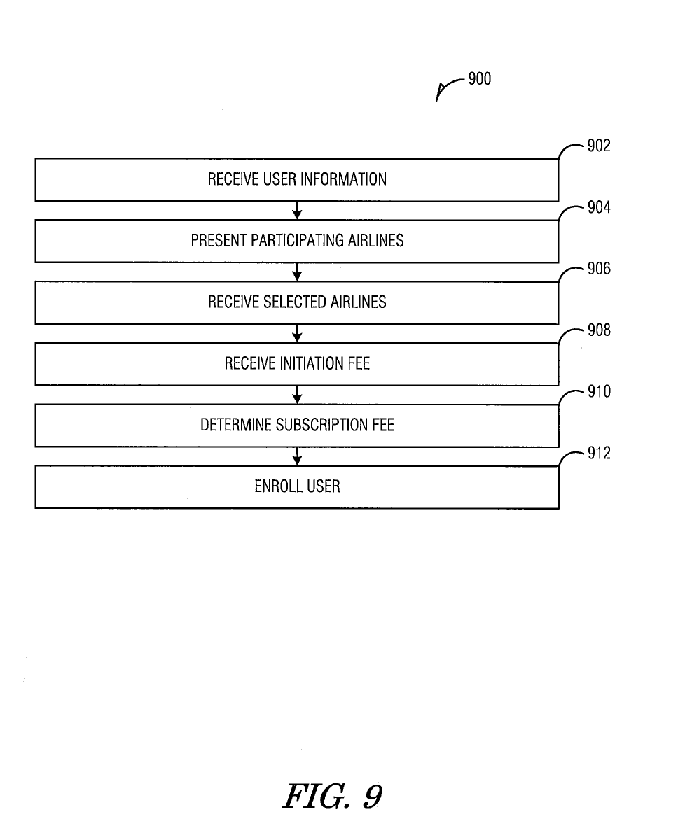

FIG. 9 is a flowchart illustrating a method 900 of signing up for a travel club according to various embodiments. At 902, user information is received at a travel club system 110. The user information may be received at a travel club system 110 or at an affiliate with the travel club 118 and forwarded to the travel club system 110. The user information may include identification information, such as a user's name, address, phone number, and other contact information, along with billing information, such as a credit card account, a bank account, or the like. The user may have to pay an initiation or enrollment fee to sign up for membership. After receiving the user's information, the travel club system presents one or more participating airlines to the user (block 904). The user may then select (block 906) one or more of the participating airlines to include in their membership coverage. At 908, the initiation fee is received. In an embodiment, the initiation fee may be calculated using the number of airlines the user selected at block 906. In another embodiment, the initiation fee may be a flat fee. In yet another embodiment, the initiation fee may include a flat fee portion and a variable portion, where the variable portion may be a calculated as a function of the selected airlines.

After the user has selected their choice of airlines, a subscription fee may be calculated (block 910). The subscription fee may be based on the number, type, order, or other characteristic of the selected airlines, in various embodiments. The subscription fee may be billed to the user on a periodic or regular basis, such as monthly, quarterly, or annually. The initiation fee and/or the subscription fee may be divided among the participating or selected airlines, for example, by a pre-arranged agreement between the travel club 118 and the selected participating airlines 116, in various embodiments. For example, the subscription fee may be split among the airlines using a proportionate measure, such as by the number of seats, flights, routes, or other characteristics of the selected participating airlines 116. The user is then enrolled in the club (block 912) using the selected airlines and the determined subscription fee.

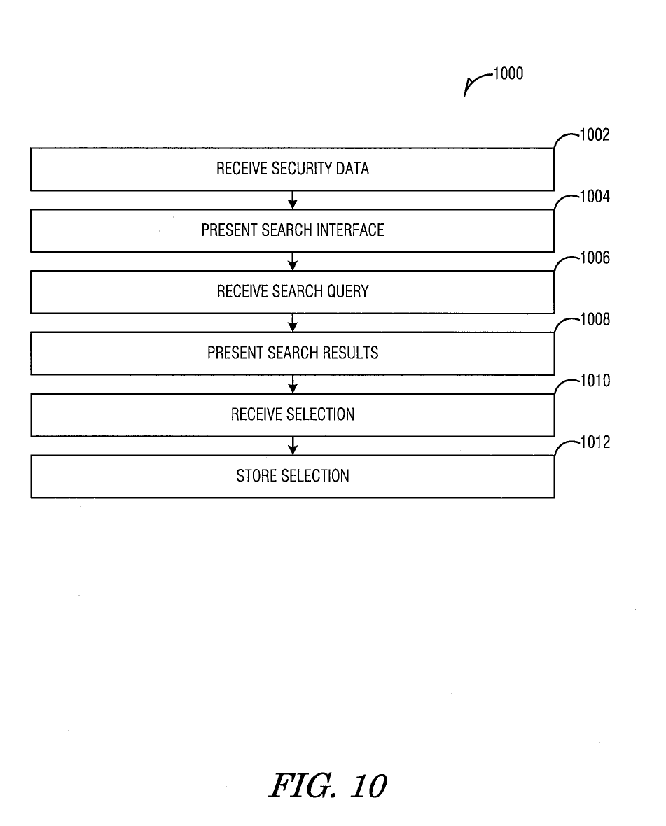

FIG. 10 is a flowchart illustrating a method 1000 of accessing a travel club according to various embodiments. At 1002, security data is received from a user. Security data may include a username and password, for example. A search interface is presented to the user (block 1004) after authentication is complete. The search interface may presented in a graphical user-interface, for example, using a web browser and a corresponding markup language (e.g., HTML). A search query is received at 1006. The search query may include a date range, an airline preference, a number of passengers, a departure city, an arrival city, and other search criteria related to a travel itinerary (e.g., whether a direct flight is preferable, a maximum number of stops or layovers, a booking class preference, or a time of day during which travel is preferred). The search query may also include one or more user-selected airlines from a plurality of airlines participating in a travel club, one or more pricing models associated with each of the plurality of airlines, and other aspects of travel, such as a departure date, a departure location, or an arrival location. At 1008, search results are presented to the user. The search results may be sorted or grouped in various manners, such as by price, by airline, by the number of total flights to reach a destination, by departure time, by arrival time, by travel discount, by reward points, or other characteristics of flights, airline clubs, or travel clubs. The user may make a selection, which is received (block 1010) by the travel club system 110. The travel club system 110 may then store the selected itinerary (block 1012), for example in the travel club database 208.

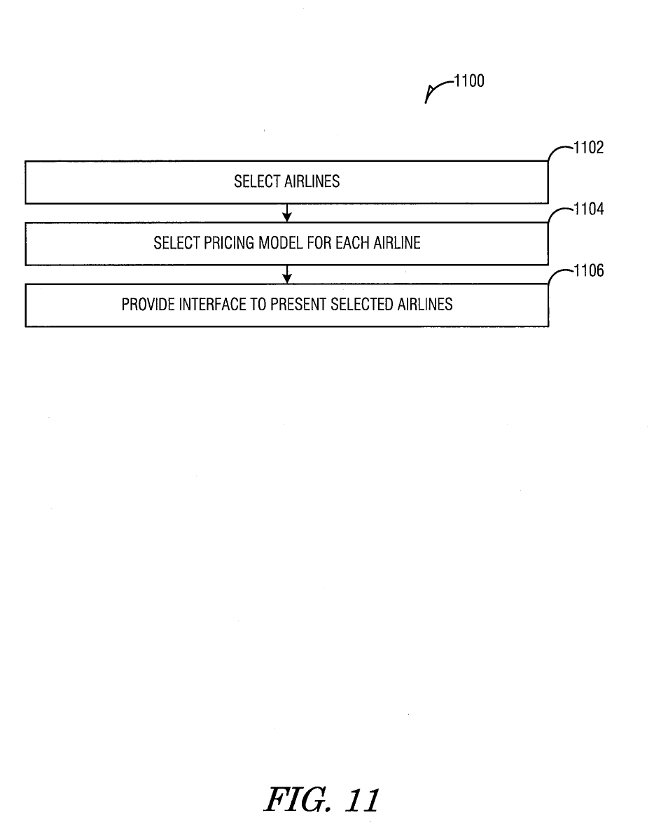

FIG. 11 is a flowchart illustrating a method 1100 of configuring a travel club. At 1102, one or more airlines are selected to form a set of airlines participating in a travel club. Each participating airline is associated with a pricing model (block 1104). Examples of pricing models are described above with reference to FIG. 5. A user interface is provided to a travel club member (block 1106). The user interface may include a search interface to search the set of participating airlines for a price associated with the pricing model for each of the airlines in the set of participating airlines. In an embodiment, the set of participating airlines share a common pricing model. An example of this embodiment is illustrated in FIG. 6. In an embodiment, the pricing model for each of the airlines in the set of participating airlines is selected from a plurality of available pricing models for each of the airlines in the set of participating airlines. An example of this embodiment is illustrated in FIG. 5. In an embodiment, the pricing model for all of the airlines in the set of participating airlines is selected from a plurality of available common pricing models. An example of this embodiment is illustrated in FIG. 7.

### User-Interfaces

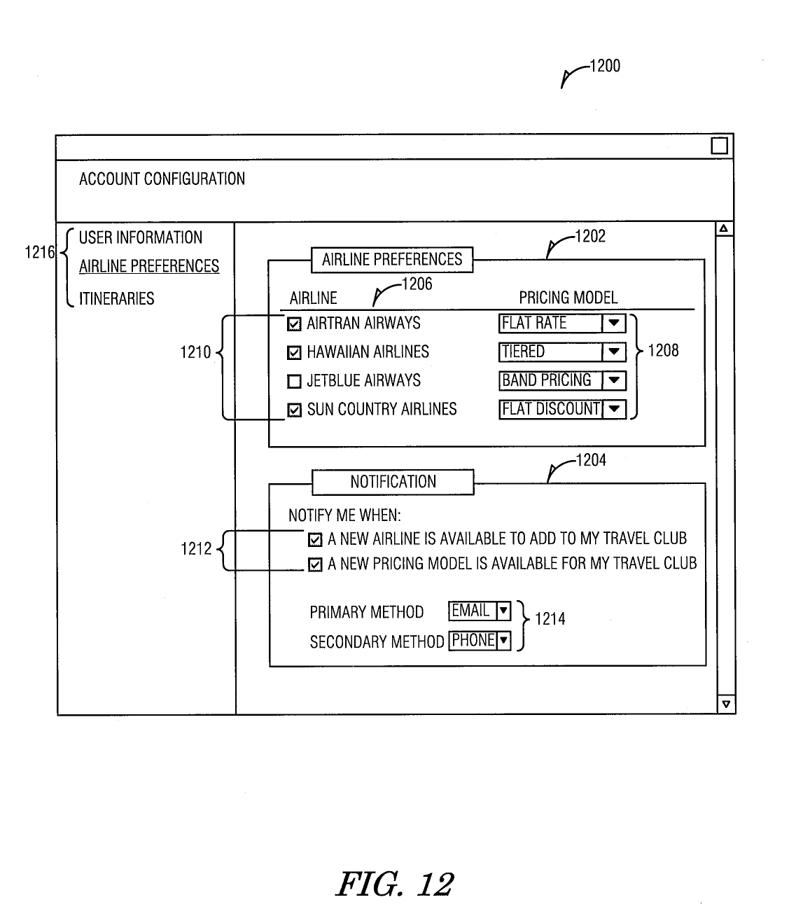

In various embodiments, the travel club system 110 may be configured to provide graphical interfaces that a user can access to sign-up, authorize, and manage the user's account and travel itineraries. FIG. 12 describes an example of a user-interface that may be implemented in a graphical user-interface, such as a web browser or other suitable graphical interface.

FIG. 12 is an example of a graphical user-interface 1200 according to various embodiments. The user-interface 1200 includes airline preference controls 1202 and notification controls 1204.

The airline preference controls 1202 include a list of participating airlines 1206 and a corresponding pricing model control 1208. The user may select of deselect a participating airline using the airline selection control 1210. The user may also select a corresponding pricing model for each airline using the pricing model control 1208, which is, in this example embodiment, represented using a dropdown list control. In an embodiment, the airline preference controls 1202 are presented using a hierarchal control. For example, airlines or related services (e.g., car rental, day tour packages, etc.) may be grouped and each group may be presented in an expanding/collapsing user-interface element. As another example, airlines or related services may be nested, such that several levels of a hierarchy may be used to represent the nested relationships.

The notification controls 1204 include opt-in controls 1212 for notification of events and delivery controls 1214. The user may select which events to be notified of, if any, using the opt-in controls 1212. In addition, the user may select a primary and secondary method of communication using the delivery controls 1114.

The user may use navigation controls 1216 to view, modify, and manage other aspects of a travel club account. For example, the user may activate the “User Information” navigation control to edit and manage the user's contact information (e.g., physical address, email address, telephone number), security information (e.g., username, password), billing information (e.g., credit card account, bank account, online payment, view statements), or the like. As another example, the user may activate the “Itineraries” navigation control to view past itineraries, current itineraries, planned itineraries, mock itineraries, or the like.

### Hardware and Software Platform

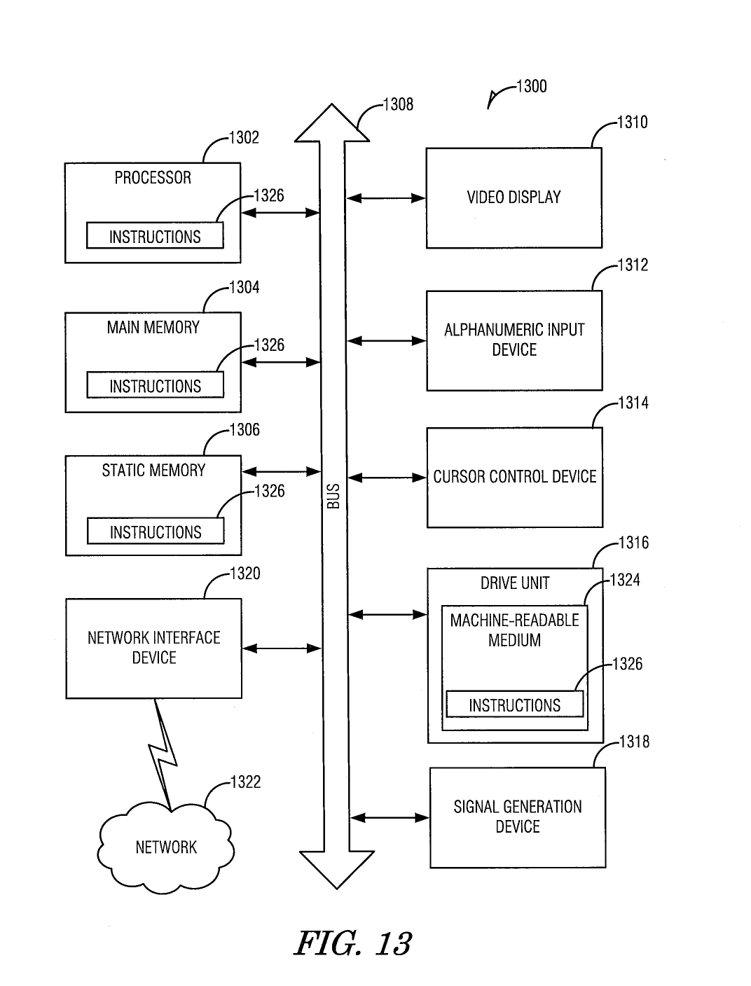

FIG. 13 is a block diagram illustrating a machine in the example form of a computer system 1300, within which a set or sequence of instructions for causing the machine to perform any one of the methodologies discussed herein may be executed, according to various embodiments. In alternative embodiments, the machine may comprise a computer, a network router, a network switch, a network bridge, Personal Digital Assistant (PDA), a cellular telephone, a web appliance, set-top box (STB) or any machine capable of executing a sequence of instructions that specify actions to be taken by that machine.

The computer system 1300 includes a processor 1302, a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a cursor control device 1314 (e.g., a mouse), a disk drive unit 1316, a signal generation device 1318 (e.g., a speaker) and a network interface device 1320 to interface the computer system to a network 1322.

The disk drive unit 1316 includes a machine-readable medium 1324 on which is stored a set of instructions or software 1326 embodying any one, or all, of the methodologies described herein. The software 1326 is also shown to reside, completely or at least partially, within the main memory 1304 and/or within the processor 1302. The software 1326 may further be transmitted or received via the network interface device 1320.

For the purposes of this specification, the term “machine-readable medium” or “computer-readable medium” shall be taken to include any medium which is capable of storing or encoding a sequence of instructions for execution by the machine and that cause the machine to perform any one of the methodologies. The terms “machine-readable medium” or “computer-readable medium” shall accordingly be taken to include, but not be limited to, solid-state memories, optical and magnetic disks, and other temporary, transient, or permanent storage means. Further, it will be appreciated that the software could be distributed across multiple machines or storage media, which may include the machine-readable medium.

Method embodiments described herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer-readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. For example, one module may be implemented as multiple logical modules, or several modules may be implemented as a single logical module. As another example, modules labeled as “first,” “second,” and “third,” etc., may be implemented in a single module, or in some combination of modules, as would be understood by one of ordinary skill in the art.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims.

What is claimed is:

1. A system comprising:
a client computer;
a server computer, communicatively connected to the client computer with a network system; and
a processing system to run on the client computer, wherein the processing system is configured to:
present indications of a plurality of participating airlines to a user, wherein the participating airlines are included in a travel club;
receive a selection of at least one airline from the plurality of airlines from the user; and
use a pricing model to determine a fare for a flight associated with the selected at least one airline, wherein the pricing model is associated with the travel club.

2. The system of claim 1, wherein the processing system is configured to:
identify the number of user-selected airlines selected from the plurality of airlines; and
set the subscription fee based on the number of user-selected airlines.

3. The system of claim 1, wherein the processing system is further configured to:
assign the user a pricing model associated with the at least one user-selected airline.

4. The system of claim 3, wherein assigning the user the pricing model comprises:
determining a user criteria; and
using the user criteria to assign the pricing model.

5. The system of claim 4, wherein the user criteria is a criterion selected from the group consisting of: a user membership status, a user purchase history, and a user demographic data.

6. The system of claim 1, wherein the processing system is further configured to:
receive a user-selection of a pricing model for each of the at least one user-selected airlines, wherein each pricing model is selected from one or more pricing models associated with each of the at least one user-selected airlines.

7. The system of claim 1, wherein the processing system is further configured to:
receive a user selection of a pricing model to be used for each of the at least one user-selected airlines, the pricing model selected from a plurality of available pricing models.

8. A method of signing up for a travel club, comprising:
receiving user information from a user;
receiving an initiation fee, wherein the initiation fee is to enroll in a travel club offering access to a plurality of participating airlines;
presenting indications of the plurality of participating airlines to the user;
receiving at least one user-selected airline, selected from the plurality of airlines;
determining a subscription fee; and
enrolling the user in the travel club.

9. The method of claim 8, wherein determining a subscription fee comprises:
identifying the number of user-selected airlines selected from the plurality of airlines; and
setting the subscription fee based on the number of user-selected airlines.

10. The method of claim 8, comprising:
assigning the user a pricing model associated with the at least one user-selected airline.

11. The method of claim 10, wherein assigning the user the pricing model comprises:
determining a user criteria; and
using the user criteria to assign the pricing model.

12. The method of claim 1 1, wherein the user criteria is a criterion selected from the group consisting of: a user membership status, a user purchase history, and a user demographic data.

13. The method of claim 8, comprising:
receiving a user-selection of a pricing model for each of the at least one user-selected airlines, wherein each pricing model is selected from one or more pricing models associated with each of the at least one user-selected airlines.

14. The method of claim 8, comprising:
receiving a user-selected of a pricing model to be used for each of the at least one user-selected airlines, the pricing model selected from a plurality of available pricing models.

15. A method of using a travel club, comprising:
receiving security data;
presenting a search interface when the security data authenticates a user associated with the security data;
receiving a search query from the user, wherein the search query is directed to search a travel club system for a matching flight;
presenting a search result related to the search query, wherein the search result includes respective flights selected from a plurality of participating airlines in the travel club;
receiving a selected flight; and
storing the selected flight.

16. The method of claim 15, further comprising:
constructing the search query to include one or more user-selected airlines from the plurality of participating airlines in the travel club; one or more pricing models associated with the plurality of participating airlines; and one or more aspects of travel.

17. The method of claim 16, wherein the one or more aspects of travel include at least a departure date, a departure location, and an arrival location.

18. A computer-implemented method of configuring a travel club, comprising:
selecting a set of one or more airlines to form a set of participating airlines;
selecting a pricing model for each of the airlines in the set of participating airlines; and
providing an interface to a travel club member, the interface including a search interface to search the set of participating airlines for a price associated with the pricing model for each of the airlines in the set of participating airlines.

19. The computer-implemented method of claim 18, wherein the set of participating airlines share a common pricing model.

20. The computer-implemented method of claim 18, wherein the pricing model for each of the airlines in the set of participating airlines is selected from a plurality of available pricing models for each of the airlines in the set of participating airlines.
